(19) United States
(12) Patent Application Publication
(10) Pub. No.: US 2008/0308044 A1
(43) Pub. Date: Dec. 18, 2008

(54) Portable pet dish

(75) Inventor: Frank R. Tiemann, Madison Lake, MN (US)

Correspondence Address: NIKOLAI & MERSEREAU, P.A., 900 SECOND AVENUE SOUTH, SUITE 820, MINNEAPOLIS, MN, 55402, US

(73) Assignee: NIFTY HOME PRODUCTS, INC., Madison Lake, MN (US)

(21) Appl. No.: 11/811,772

(22) Filed: Jun. 12, 2007

(51) Int. Cl. A01K 29/00

(52) U.S. Cl. 119/61.5

(57) ABSTRACT

A portable dish assembly for feeding a domesticated animal comprising at least two dishes and a frame for holding the dishes wherein said frame includes a plurality of dish holding members which are foldable with respect to each other. Each dish having a substantially concaved interior and equipped with a lid selectively coupled to the dish such that when the lid covers the dish the lid denies access to the concaved interior. A hinge couples the two dish holding members together. The dish holding members include a first ring sized to surround the perimeter of one of the dishes and a second ring sized to surround the perimeter of the cylindrical base of said dish. A plurality of leg members couple the first loop to the second loop in a spaced-apart relationship. Each leg member includes a first end coupled to the first ring and a second end coupled to the second ring. Each leg member is bent to provide a foot on to the leg. The hinge permits the frame to be folded such that the dish members are more compact for storage.

### BACKGROUND OF THE INVENTION

I. Field of the Invention

The invention disclosed herein relates to a portable domestic animal feed dish.

II. A State of the Art

Pet owners are frequently faced with the dilemma of caring for their pet when they are away from their home. One solution was to fill common pet dishes before leaving the home for a prolonged absence. The problem with this approach is it risks having the home invaded by pests and bad odors. Moreover, this solution does not consider the pet's dietary needs. Additionally, the typical house pet does not have the discipline to ration out its food and water over the duration of its master's absence. Therefore, the pet will often times eat and drink all of its food and water in one sitting leaving it without fresh food and water for the remainder of its owner's absence. Practically, the typical pet dish is not sufficiently large enough to guarantee sufficient food and water until the return of the pet owner. This approach also assumes that the pet is sufficiently well trained and can be left alone in the home for an extended absence (i.e. over the weekend).

Still another solution is to place the pet in a kennel for the weekend. However, kennel stays can frequently be expensive and economically prohibitive for the owner. Furthermore, many pet owners feel that it is cruel to abandon their pet, for even a weekend, and wish to be able to travel with their pet. Several attempts at addressing these needs have been made. For example, it is well known in the art to have a dish with a timed opening for feeding dogs and cats. Dishes with a timed opening typically have a number of compartments which vary according to the number of days the pet owner will be absent. Each compartment has a lid which is regulated by a timer and the timer is programmed before the owner leaves. The timer ensures that the meal remains exposed only during a pre-set time, thus maintaining fresh food and preventing the animal from overeating. This approach, assumes that the dog has the discipline to be left alone or that the owner does not wish to bring the animal with her. For the foregoing reasons it would be advantageous to have a portable pet dish assembly equipped with a lid that can easily be carried wherever a pet owner wishes to bring her pet.

### SUMMARY OF THE INVENTION

A portable dish assembly for feeding a domesticated animal having a plurality of dishes and a frame for holding the dishes is provided. The dishes comprise an annular base member, an exterior bowl member mounted to said annular base member, and a substantially concaved interior bowl member resting inside said exterior bowl member. Food articles may be placed inside said interior bowl member. The dishes further include a lid which may be used to selectively cover the interior bowl such that when the lid covers the interior bowl said lid denies access to food articles placed in the interior bowl. The frame includes a plurality of dish holding members wherein each dish holding member holds one of the plurality of dishes. A hinge member couples two of the dish holding members together in such a manner that both the first and second dish holding members are foldable with respect to each other by the hinge member. A handle member is coupled to one of the frame places the bowls in a vertical position.

Additional features of the disclosure will become apparent to those skilled in the art upon consideration of the following detailed description of illustrated embodiments exemplifying the best mode of carrying out the disclosure as presently perceived.

### A BRIEF DESCRIPTION OF THE DRAWINGS

The detailed descriptions particularly refer to the following figures in which:

FIG. 1 is a perspective view of the portable dish assembly showing a frame holding the plurality of dishes in a horizontal position;

FIG. 2 is a side view of one of the assembly shown in FIG. 1;

FIG. 3 is a perspective view of the portable dish assembly of FIG. 1 wherein the frame assembly is in a vertical position;

FIG. 4 is a plan view of a lid to be used to cover a dish.

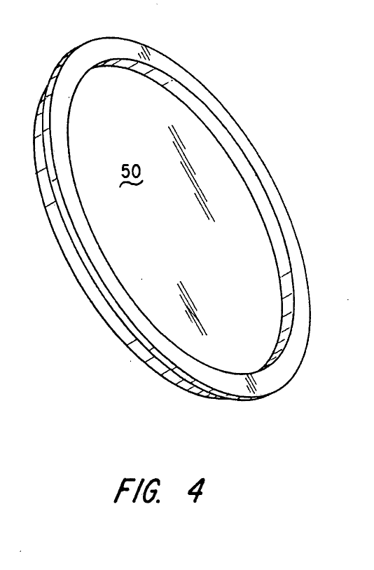

### DETAILED DESCRIPTION OF THE INVENTION

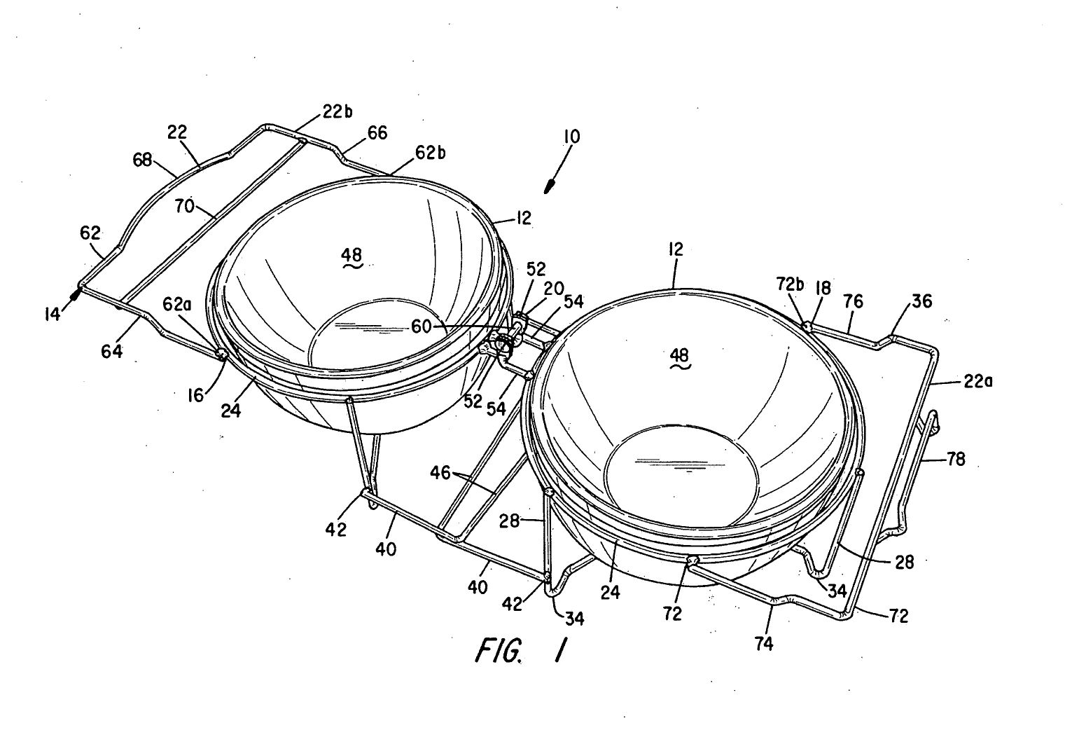

A portable dish assembly 10 includes a plurality of dishes 12 and a frame assembly 14. The frame assembly 14 holds the dishes 12 so that when a pet is eating out of one said dishes the dish will not tip over. In the preferred embodiment shown in FIG. 1 the frame 14 includes a first and second dish holding member 16, 18. Each of the dish holding members 16, 18 are coupled together by a hinge member 20. The hinge member 20 allows the first dish holding member 16 to be foldable with respect to the second dish holding member 18. The frame assembly also includes a handle member 22.

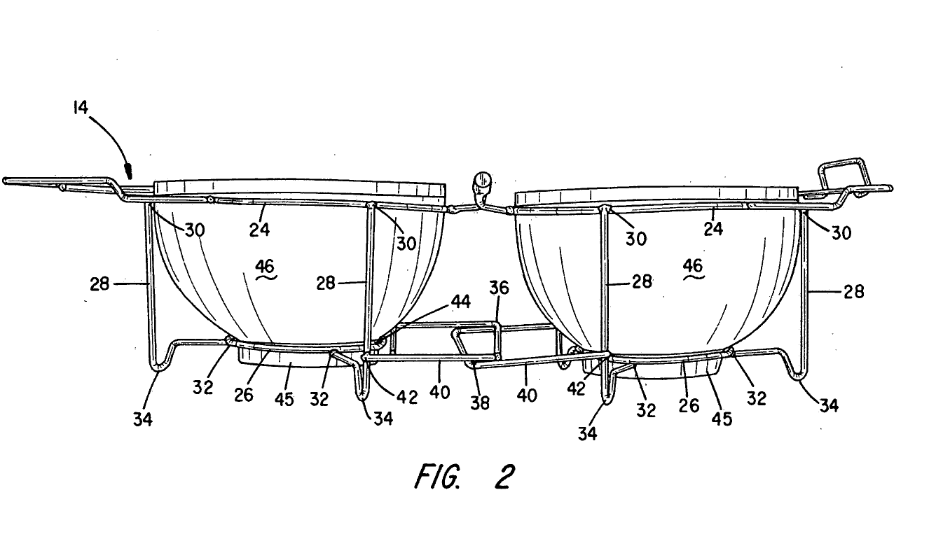

The dish holding members 16, 18 of the portable dish assembly 10 each include a first generally circular loop 24 made of a metal wire. The dish holding members 16, 18 also include a second generally circular loop 26 also made of metal wire. The first loop 24 and the second loop 26 are coupled together by a plurality of leg members 28. Each leg member 28 is made of a metal wire. Each leg member 28 has a first and 30 and a second end 32. Each leg 28 is coupled at its first end 30 to the first loop 24 and the leg extends downwardly to a rounded foot 34. The foot 34 is formed when the leg 28 is bent at a u-shape as best seen in FIG. 2. The second end 32 of each leg 28 is coupled to the second circular loop 26 so that the first loop 24 is positioned generally centered above of the second loop 26 when the assembly is oriented as in FIG. 2. In the preferred embodiment each dish holding member 16, 18 has three such leg members 28.

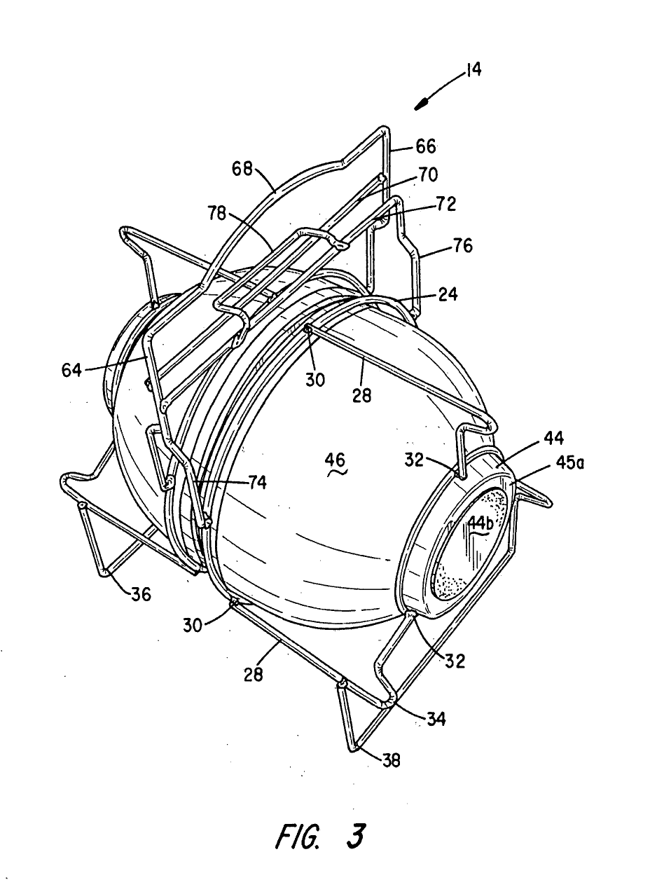

Each dish holder member 16, 18 further includes stabilizing tabs 36, 38 wherein said stabilizing tabs 36, 38 also include a formed wire member 40 joined as by welding at opposed ends 42, 44 to two opposing leg members 28. Each wire member 40 is bent at opposed right angles so that a crossbar 46 is integrally formed by the wire member 40. As shown in FIGS. 1 and 2, when the frame 14 is in its open position, it holds the bowls 48 in a horizontal position with the tabs 36, 38 closely overlapping one another, providing extra stability to the frame 14. As shown in FIG. 3, when the frame 14 is folded about hinge member 20 to its closed, vertical position the stabilizing tabs 36, 38 act as legs for the frame 14 when one wants to store said frame on a shelf.

Each dish 12 includes a generally cylindrical base member 45, and exterior bowl 46 and an interior bowl 48. The exterior bowl 46 is mounted on the cylindrical base member 45. The underside 45a of the cylindrical base member 45 may be covered in a rubber layer 44b to prevent scuffing of the floor and to inhibit the dish from skidding when pushed by the snout of an animal feeding from the dish. The interior bowl 48 is substantially concaved so that the interior bowl 48 may hold food and water. The interior bowl 48 is surrounded by the exterior bowl 46. A lid 50 is provided to cover the interior bowl and its content.

As shown in FIG. 1, the hinge 20 couples the two dish holding members 16, 18 together so that the first dish holding member 16 is foldable with respect to the second dish holding member 18. The hinge 20 includes a first pair of tabs 52 that extend from and are integrally formed with the first loop 24 of the first dish holding member 16. A second pair of tabs 56 is integrally formed with and extends from the first circular loop of the second dish holding member 18. Likewise, each of the second pair of tabs 56 has an opening running through it. A hinge pin 60 runs through the aligned openings (not shown) in the tabs 52, 56 so that hinge members pivot about the hinge pin 60. This allows the first dish holding member 16 to be foldable with respect to the second dish holding member 18.

When the frame 14 is placed in an open, horizontal position (as in FIG. 1) wherein the feet 34 of the legs 28 are all placed on a horizontal surface and each of the dish holding members 16, 18 are held in parallel relationship to one another except that the stabilizing tabs 36, 38 are overlaying one another as previously described. When the frame 14 is in said open position the dish members 12 are held by the dish holding members 16, 18. Specifically, the cylindrical base member 45 is closely surrounded by the second circular loop 26. Likewise, the first loop 24 encircles the top of the dish 12. The first loop 24 and second loop 26 securely holds the dish 12 to prevent the dish from being pushed around by the pet.

The frame assembly 14 also includes a handle that comprises a first handle wire 62 coupled to the first loop 24 of the first holder 16. The wire handle 62 has a first end 62A and a second end 62B each welded or otherwise coupled to the loop 24. The wire 62 is bent so as to exhibit a first side 64 and a second side 66 opposed to one another and a bent central section 68 running between the first end 64 and the second end 66. A second handle wire 70 runs from the first side 64 to the second side 66 parallel to the bent central member 68.

The second dish holding member 18 has a second wire 72 bent in a u-shape and welded at its ends to the first loop 24. The second bent wire 72 is bent to have two right angles forming side members 74 and 76. The first end 72A of the bent wire 72 is welded or otherwise attached to the loop 24 as is the second end 72B. A latch 78 is affixed to the wire 72 between sides 74 and 76.

As shown in FIG. 3 when the first dish holding member 16 is folded over the second dish holding member 18, the latch 78 engages crossbar 70 to lock the frame 14 in a closed position.

The invention has been described here in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures can be accomplished without departing from the scope of the invention itself.

What is claimed is;

1. A portable dish tray assembly for feeding a domesticated animal, said portable dish tray assembly comprising:
a) at least two dishes wherein each dish has a substantially concaved interior and a lid selectively coupled to said interior bowl such that when the lid covers the dish the lid denies access to the dish;
b) a frame for holding said dishes, said frame including at least two dish holding members wherein each dish holding member holds a dish, a hinge member for coupling two of the dish holding members together in such a manner that both the first of two dish holding members and the second of two dish holding member are foldable with respect to each other from a closed disposition to an open disposition, said frame also having and a handle member for carrying the frame when the frame is in said closed disposition.

2. The portable dish assembly as in claim 1 wherein each dish comprises a base member, an exterior wall member adapted to be mounted on said base member, and a substantially concaved interior wall member resting inside said exterior bowl member to form a bowl.

3. The portable dish assembly as in claim 2 wherein the base member is cylindrical.

4. The portable dish assembly as in claim 2 wherein the dish holding members include a first ring sized to surround a perimeter of one of the dishes, a second ring sized to surround the perimeter of the base of said dish, and a plurality of leg members, wherein each leg member includes a first end coupled to the first ring and a second end coupled to the second ring and each leg member is bent to provide a foot member to the leg.

5. The portable dish assembly in claim 1 wherein the hinge member comprises a first pair of outwardly extending tabs, each having an opening and being affixed to the first of the two dish holding members, a second outwardly extending pair of tabs, each having an opening and being affixed to the second of the two dish holding members, and a hinge pin inserted through the openings of the outwardly extending tabs when aligned with one another so that dish holding members pivot about the hinge pin.

6. The portable dish assembly as in claim 5 wherein the dish holding members include a stabilizing tab extending between at least two of the leg members when the frame is in a horizontal position, the stabilizing tabs closely overlaying one another.

7. The portable dish assembly as in claim 1 wherein the handle member comprises;
a) a first handle wire extending from the first of two dish holding members said first handle wire including a locking bar extending from a first end to a second end of the handle wire, and;
b) a second handle wire extending from the second of two dish holding members, the second flange configured to curl over the locking bar when the first dish holding member is folded over the second dish holding member and lock the assembly in said closed disposition.
